(19) United States
(12) Patent Application Publication
(10) Pub. No.: US 2020/0092594 A1
(43) Pub. Date: Mar. 19, 2020

(54) INFORMATION PROCESSING DEVICE, INFORMATION PROCESSING METHOD, PROGRAM, AND INFORMATION PROCESSING SYSTEM

(71) Applicant: SONY NETWORK COMMUNICATIONS INC., Tokyo (JP)

(72) Inventors: Wataru KASAI, Tokyo (JP); Tomoyuki SUZUKI, Tokyo (JP); Tetsuro KIDA, Tokyo (JP); Yohei HASHIMOTO, Tokyo (JP); Yutaka KIMURA, Tokyo (JP); Taku SEIMIYA, Tokyo (JP); Makoto SUNAYAMA, Tokyo (JP); So KATAGIRI, Tokyo (JP); Asuka MOMOSE, Tokyo (JP)

(73) Assignee: SONY NETWORK COMMUNICATIONS INC., Tokyo (JP)

(21) Appl. No.: 16/472,211

(22) PCT Filed: Oct. 30, 2017
(86) PCT No.: PCT/JP2017/039156

§ 371 Date: Jun. 21, 2019

(30) Foreign Application Priority Data
Dec. 28, 2016 (JP) 2016-255427

(51) Int. Cl. H04N 21/254; H04N 21/258; H04L 29/08; H04N 21/2387; H04N 21/81

(52) U.S. Cl. CPC H04N 21/254; H04N 21/258; H04N 21/812; H04N 21/2387; H04L 67/26

(57) ABSTRACT

[Object] To make it possible to effectively guide a user to related content pertaining to a distribution program.

[Solution] Provided is an information processing device including: an extraction unit configured to, on the basis of log information pertaining to a distribution program and acquired from a distribution destination device, extract a target distribution destination device from a plurality of the distribution destination devices; an identifier specifying unit configured to acquire an identifier of a guidance target associated with an identifier of the target distribution destination device; and a guidance control unit configured to cause the guidance target to display guidance information that directs to related content pertaining to the distribution program on the basis of the identifier of the guidance target.

### TECHNICAL FIELD

The present disclosure relates to an information processing device, an information processing method, a program, and an information processing system.

### BACKGROUND ART

In recent years, as the information processing technology advances, many distribution programs targeted for many and unspecified persons are being provided. In addition, various technologies for utilizing information concerning distribution programs as described above are being developed. For example, Patent Literature 1 discloses a technology for measuring ratings of a distribution program using an application.

### CITATION LIST

### Patent Literature

Patent Literature 1: JP 2012-80248A

### DISCLOSURE OF INVENTION

### Technical Problem

In the meanwhile, in the field of program distribution as described above, means for efficiently collecting information from a user having viewed a distribution program or the like and means for effectively transferring related information to the user are being demanded. However, the technology described in Patent Literature 1 remains in collection of basic data having been set in advance by a user in addition to viewing data, and it is difficult to deal with a request on the distribution side on demand.

Therefore, the present disclosure proposes an information processing device, an information processing method, a program, and an information processing system that are novel and improved, and can effectively guide a user to related content pertaining to a distribution program.

### Solution to Problem

According to the present disclosure, there is provided an information processing device including: an extraction unit configured to, on the basis of log information pertaining to a distribution program and acquired from a distribution destination device, extract a target distribution destination device from a plurality of the distribution destination devices; an identifier specifying unit configured to acquire an identifier of a guidance target associated with an identifier of the target distribution destination device; and a guidance control unit configured to cause the guidance target to display guidance information that directs to related content pertaining to the distribution program on the basis of the identifier of the guidance target.

In addition, according to the present disclosure, there is provided an information processing method including: with a processor, on the basis of log information pertaining to a distribution program and acquired from a distribution destination device, extracting a target distribution destination device from a plurality of the distribution destination devices; acquiring an identifier of a guidance target associated with an identifier of the target distribution destination device; and causing the guidance target to display guidance information that directs to related content pertaining to the distribution program on the basis of the identifier of the guidance target.

In addition, according to the present disclosure, there is provided a program for causing a computer to function as an information processing device, the information processing device including an extraction unit configured to, on the basis of log information pertaining to a distribution program and acquired from a distribution destination device, extract a target distribution destination device from a plurality of the distribution destination devices, an identifier specifying unit configured to acquire an identifier of a guidance target associated with an identifier of the target distribution destination device, and a guidance control unit configured to cause the guidance target to display guidance information that directs to related content pertaining to the distribution program on the basis of the identifier of the guidance target.

In addition, according to the present disclosure, there is provided an information processing system including: an extraction unit configured to, on the basis of log information pertaining to a distribution program and acquired from a distribution destination device, extract a target distribution destination device from a plurality of the distribution destination devices; an identifier specifying unit configured to acquire an identifier of a guidance target associated with an identifier of the target distribution destination device; and a guidance control unit configured to cause the guidance target to display guidance information that directs to related content pertaining to the distribution program on the basis of the identifier of the guidance target; and a display unit configured to display the guidance information on the basis of control exerted by the guidance control unit.

### Advantageous Effects of Invention

According to the present disclosure as described above, it is possible to effectively guide a user to related content pertaining to a distribution program.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an embodiment of the present disclosure.

FIG. 2 is a diagram showing a system configuration example of an information processing system according to the embodiment.

FIG. 3 is an example of a functional block diagram of a distribution destination device according to the embodiment.

FIG. 4 is an example of a functional block diagram of an information processing device according to the embodiment.

FIG. 5 is an example of a functional block diagram of an information processing terminal according to the embodiment.

FIG. 6 is an example of a functional block diagram of a content server according to the embodiment.

FIG. 7 is a diagram showing an example of guidance information displayed on a display unit of the information processing terminal according to the embodiment.

FIG. 8 is a diagram showing an example of a push notification according to the present embodiment according to the embodiment.

FIG. 9 is a flowchart showing a flow of operation of the information processing device according to the embodiment.

FIG. 10 is a hardware configuration example according to the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.
1. Embodiment
1.1. Overview of embodiment
1.2. System configuration example
1.3. System configuration example of distribution destination device 10
1.4. Functional configuration example of information processing device 20
1.5. Functional configuration example of information processing terminal 30
1.6. Functional configuration example of content server 40
1.7. Specific example of display control pertaining to guidance information
1.8. Examples of analyses performed by analysis unit 260
1.9. Flow of operation of information processing device 20
2. Hardware configuration example
3. Conclusion

### 1. Embodiment

### 1.1. Overview of Embodiment

First, an overview of an embodiment according to the present disclosure will be described. As described above, in recent years, many distribution programs are being provided. A video program such as a television program (hereinafter also referred to as a TV program) and a sound program such as a radio program, for example, are included in the above-described distribution programs.

In addition, in recent years, many devices that play back distribution programs and many applications that cooperate with the devices, and the like are also being developed. For example, in a case where a distribution program is a TV program, a television device (hereinafter also referred to as a TV device) that automatically transmits a viewing log of the TV program, an application that cooperates with the TV device and has a function of displaying a program table of TV programs and a function as a remote controller for the TV device, and the like exist.

In the meanwhile, a party that produces and distributes a distribution program as described above wishes to collect, from users having viewed the distribution program, information concerning the distribution program in some cases, and wishes to transfer additional information related to the distribution program in some cases. For example, for a production company that produces a TV program and a TV station that distributes the TV program, a questionnaire collected from users having viewed the TV program may be important information for future business. In addition, for the TV station and the like, it is also an important strategy to transfer advertisements, announcements, and the like related to the TV program to users.

However, since it is difficult on the distribution side to specify users having actually viewed a distribution program in many cases, a questionnaire or an advertisement is presented to many and unspecified users including users not having viewed the distribution program, and the like in actual circumstances. In addition, since users not having viewed the distribution program may be included in subjects in the method as described above, there is a concern that the questionnaire is reduced in reliability or a concern that user's satisfaction is reduced by transmitting an advertisement to users not interested in the distribution program, or the like.

An information processing device, an information processing method, a program, and an information system according to the present embodiment have been conceived paying attention to the above-described points, and enable a user specified on the basis of actual log information pertaining to a distribution program to be guided to related content pertaining to the distribution program.

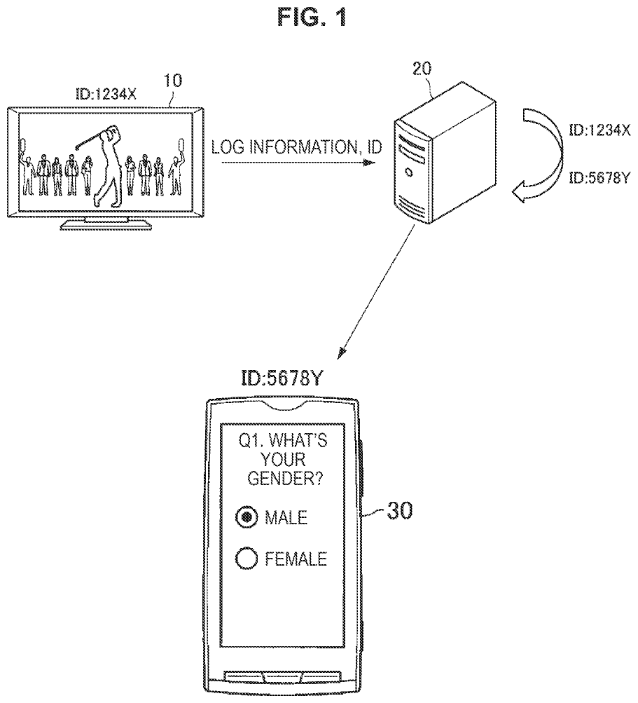

FIG. 1 is a diagram for describing an overview of the present embodiment. A distribution destination device 10, an information processing device 20, and an information processing terminal 30 according to the present embodiment are shown in FIG. 1. Note that, in the following description through use of FIG. 1, description will be given using a case in which the distribution destination device 10 is a TV device that plays back a TV program and a guidance target is an application that cooperates with the above-described TV device as an example. As described above, the above-described application may be an application having the function of displaying a program table pertaining to TV programs and the function as a remote controller.

In addition, the information processing device 20 according to the present embodiment is a device that specifies a guidance target for related content on the basis of log information acquired from the distribution destination device 10, and causes the guidance target to display guidance information that directs to the related content. In the case of the example shown in FIG. 1, the information processing device 20 extracts the distribution destination device 10 having actually played back a targeted TV program on the basis of a viewing log received from the distribution destination device 10. In addition, on the basis of the ID (1234X) of the distribution destination device 10 extracted above, the information processing device 20 acquires the ID (5678Y) pertaining to an application associated with the distribution destination device 10.

In addition, the information processing terminal 30 according to the present embodiment is an information processing device that controls operation of an application to be the above-described guidance target. That is, guidance information that directs to related content pertaining to the distribution program is displayed on a user interface of an application activated in the information processing terminal 30 on the basis of control exerted by the information processing device 20. A link or the like to a questionnaire related to a TV program, for example, may be included in the above-described guidance information. Note that an example of a questionnaire screen transitioned from guidance information is shown in FIG. 1.

As described above, in accordance with the technological idea according to the present embodiment, it is possible to guide a user specified on the basis of actual log information pertaining to the distribution program to related content pertaining to the distribution program. In this manner, in accordance with the technological idea according to the present embodiment, by efficiently limiting target users, it is possible to reduce the cost pertaining to guidance to related content, and it is possible to effectively improve effects exerted by the related content.

### 1.2. System Configuration Example

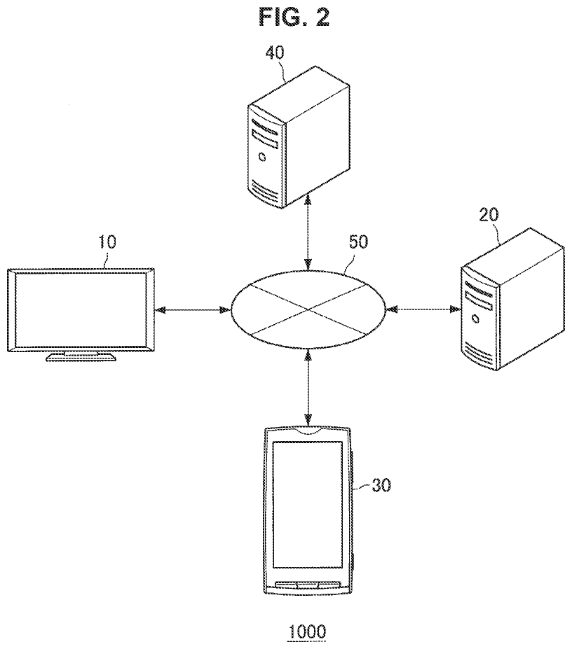

Next, a system configuration example of an information processing system 1000 according to the present embodiment will be described. FIG. 2 is a diagram showing a system configuration example of the information processing system 1000 according to the present embodiment. Referring to FIG. 2, the information processing system 1000 according to the present embodiment may include the distribution destination device 10, the information processing device 20, the information processing terminal 30, and a content server 40, for example. In addition, the above-described respective components are connected so as to be capable of making communication with each other via a network 50.

### (Distribution Destination Device 10)

The distribution destination device 10 according to the present embodiment is a device that performs processing on a distribution program to be distributed. Here, various video programs, sound programs, and the like are included in the above-described distribution program. Examples of video programs include a TV program and a moving image program distributed on the Internet. In addition, sound programs include a radio program, a podcast program, and the like.

In addition, processing pertaining to playback and recording of the distribution program may be included in the above-described processing on the distribution program. Thus, a playback device and a recording device for the distribution program may be included in the distribution destination device according to the present embodiment. For example, in a case where the distribution program is a TV program, the distribution destination device 10 may be a TV device, a recording device, or the like. In addition, in a case where the distribution program is a moving image program, a podcast, or the like distributed on the Internet, the distribution destination device 10 may be a personal computer (PC), a smartphone, a tablet, a mobile phone, a wearable device, or the like.

In addition, the distribution destination device 10 according to the present embodiment has a function of transmitting log information pertaining to the distribution program to the information processing device 20. For example, in a case where the distribution destination device 10 is a TV device, the distribution destination device 10 may transmit log information pertaining to viewing of a TV program to the information processing device 20 every five minutes or the like. In addition, when acquiring log information as described above, the distribution destination device 10 is also capable of transmitting the log information immediately.

### (Information Processing Device 20)

The information processing device 20 according to the present embodiment is a device that specifies a guidance target for related content pertaining to a distribution program on the basis of log information transmitted from the distribution destination device 10 and an identifier, and causes the guidance target to display guidance information that directs to the related content. More specifically, on the basis of the identifier of the distribution destination device 10 having log information conforming to an extraction condition, the information processing device 20 according to the present embodiment can acquire an identifier of the guidance target associated with the identifier. In addition, on the basis of the identifier of the guidance target acquired above, the information processing device 20 according to the present embodiment can cause the guidance target to display guidance information that directs to the related content.

Here, an application, various services, an operating system (OS), a device, and the like associated with the distribution destination device 10 may be included in the above-described guidance target. The information processing device 20 according to the present embodiment can control the guidance target as described above on the basis of the identifier associated with the distribution destination device 10.

In addition, various identifiers may be used for specifying the guidance target according to the present embodiment. For example, in a case where the guidance target is an application, an application ID specific to the application, a user ID specific to a user who uses the application, an e-mail address, an IP address, a common ID used in common with another service, a so-called advertisement ID utilized for an advertisement distribution identification application, and the like may be used. Thus, in a case where the identifier is the above-described common ID or advertisement ID, or the like, the information processing device 20 according to the present embodiment can cause a plurality of guidance targets to display guidance information on the basis of a single identifier.

### (Information Processing Terminal 30)

The information processing terminal 30 is an information processing device that provides a user with an application, a service, OS, or the like to be a guidance target. In addition, as described above, the information processing terminal 30 according to the present embodiment may also be a guidance target. The information processing terminal 30 has a function of displaying guidance information that directs to related content pertaining to the distribution program on the basis of control exerted by the information processing device 20. The information processing terminal 30 according to the present embodiment may be a PC, a smartphone, a tablet, a mobile phone, a wearable device, or the like, for example.

### (Content Server 40)

The content server 40 according to the present embodiment is an information processing device that provides related content pertaining to a distribution program. In a case where the related content is web content, the content server 40 may have a function as a web server. Note that a questionnaire, an advertisement, an announcement, and the like pertaining to a distribution program, for example, may be included in the related content according to the present embodiment.

### (Network 50)

The network 50 has a function of connecting the distribution destination device 10, the information processing device 20, the information processing terminal 30, and the content server 40. The network 50 may include a public network such as the Internet, a telephone network, or a satellite communication network, each type of local area network (LAN) including Ethernet (registered trademark), a wide area network (WAN), and the like. In addition, the network 50 may include a private network such as Internt Protocol-Virtual Private Network (IP-VPN).

The system configuration example of the information processing system 1000 according to the present embodiment has been described above. Note that the above-described configuration described using FIG. 2 is merely an example, and the configuration of the information processing system 1000 according to the present embodiment is not limited to such an example. For example, the functions that the information processing device 20 has may be achieved by being distributed to a plurality of devices. In addition, for example, the functions that the information processing device 20 and the content server 40 have may be provided by a single device. The system configuration of the information processing system 1000 according to the present embodiment may be modified flexibly in accordance with system specifications, an operation policy, or the like.

### 1.3. System Configuration Example of Distribution Destination Device 10

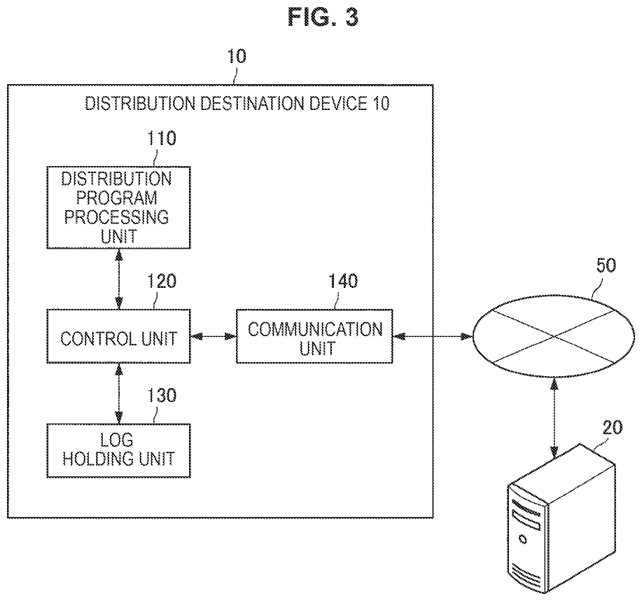

Next, a system configuration example of the distribution destination device 10 according to the present embodiment will be described. FIG. 3 is an example of a functional block diagram of the distribution destination device 10 according to the present embodiment. Referring to FIG. 3, the distribution destination device 10 according to the present embodiment includes a distribution program processing unit 110, a control unit 120, a log holding unit 130, and a communication unit 140.

### (Distribution Program Processing Unit 110)

The distribution program processing unit 110 according to the present embodiment has a function of performing various types of processing on a distribution program received via the network 50. As described above, a video program such as a TV program and a sound program such as a radio program are included in the above-described distribution program. Thus, the distribution program processing unit 110 according to the present embodiment has a function of performing playback and recording (including recording reservation) of a video program or a sound program, for example.

### (Control Unit 120)

The control unit 120 according to the present embodiment has a function of controlling operations of the distribution program processing unit 110 and the log holding unit 130. The control unit 120 can cause the distribution program processing unit 110 to play back or record a distribution program on the basis of an input manipulation made by a user, for example.

### (Log Holding Unit 130)

The log holding unit 130 according to the present embodiment has a function of storing a log pertaining to the distribution program on the basis of a processing operation performed by the distribution program processing unit 110. For example, in a case where the distribution program is a TV program, the log holding unit 130 according to the present embodiment can record a channel ID (station ID), a program ID, a playback start time, a playback finish time, and the like pertaining to a TV program recorded or played back by the distribution program processing unit 110. In addition, the log holding unit 130 may record the ID pertaining to a CM program, whether or not playback has been performed (whether or not skip has been performed), and the like.

### (Communication Unit 140)

The communication unit 140 according to the present embodiment has a function of performing information communication with the information processing device 20 and the like via the network 50. Specifically, the communication unit 140 transmits log information pertaining to a distribution program recorded by the log holding unit 130 to the information processing device 20. On this occasion, the communication unit 140 according to the present embodiment may transmit the above-described log information periodically to the information processing device 20 every five minutes, for example. Note that, when log information is acquired, the communication unit 140 may transmit the log information immediately to the information processing device 20. In addition, the communication unit 140 transmits an identifier such as ID, an IP address, and the like pertaining to the distribution destination device 10 together with the above-described log information.

The functional configuration example of the distribution destination device 10 according to the present embodiment has been described above. Note that the above-described functional configuration described using FIG. 3 is merely an example, and the functional configuration of the distribution destination device 10 according to the present embodiment is not limited to such an example. The distribution destination device 10 according to the present embodiment may further include components other than those described above. The distribution destination device 10 may include an input unit that receives a manipulation input made by a user and an output unit that outputs a distribution program, for example. The functional configuration of the distribution destination device 10 according to the present embodiment may be modified flexibly.

### 1.4. Functional Configuration Example of Information Processing Device 20

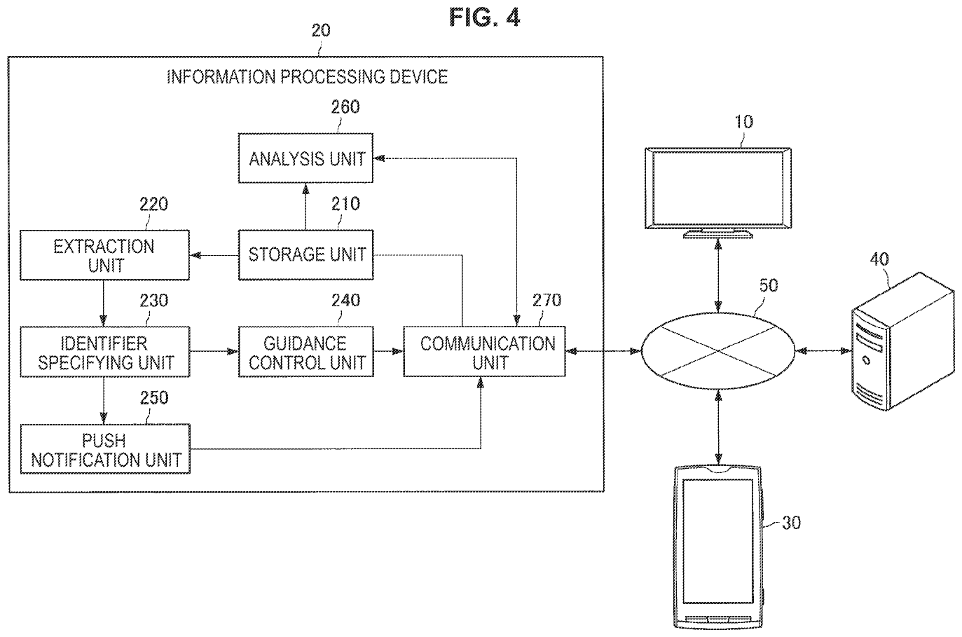

Next, a functional configuration example of the information processing device 20 according to the present embodiment will be described. FIG. 4 is an example of a functional block diagram of the information processing device 20 according to the present embodiment. Referring to FIG. 4, the information processing device 20 according to the present embodiment includes a storage unit 210, an extraction unit 220, an identifier specifying unit 230, a guidance control unit 240, a push notification unit 250, an analysis unit 260, and a communication unit 270.

### (Storage Unit 210)

The storage unit 210 according to the present embodiment has a function of storing information handled by each function of the information processing device 20. For example, the storage unit 210 according to the present embodiment stores log information pertaining to a distribution program transmitted from the distribution destination device 10. On this occasion, the storage unit 210 may accumulate log information received from a plurality of distribution destination devices 10. In addition, the storage unit 210 stores an identifier of a guidance target associated with the identifier of the distribution destination device 10. On this occasion, the storage unit 210 may store information regarding IP addresses transmitted from the distribution destination device 10 and the guidance target together with the above-described identifier. Furthermore, the storage unit 210 stores input information for related content transmitted from the content server 40.

### (Extraction Unit 220)

The extraction unit 220 according to the present embodiment has a function of extracting a target distribution destination device from a plurality of distribution destination devices 10 on the basis of log information pertaining to a distribution program stored in the storage unit 210 and various extraction conditions. Note that, for the above-described extraction conditions, a plurality of either channel IDs or program IDs as described above, or combinations thereof, or the like may be set, for example. In addition, in such a case where the same TV program is broadcasted in a plurality of TV stations, different channel IDs or program IDs are set for the same TV program in some cases, and thus, a high-order ID that can designate all the programs broadcasted in the plurality of TV stations or the like may be used.

In addition, for the extraction conditions according to the present embodiment, contents of processing on a distribution program may be set. For example, the extraction unit 220 according to the present embodiment may extract a distribution destination device having executed predetermined processing on a distribution program as a target distribution destination device on the basis of the above-described log information. Here, processing pertaining to playback or recording is included in the above-described processing on a distribution program. For example, in a case where the distribution program is a TV program, the extraction unit 220 can extract the distribution destination device 10 having actually played back a TV program designated by the ID or the like as described above or the distribution destination device 10 having performed recording (or recording reservation) as a target distribution destination device.

As an example that may be set as an extraction condition, for example, a case in which a certain TV program is played back for a predetermined time or longer, a case in which another TV program broadcasted in the same time slot as a certain TV program is played back, a case in which playback is switched from a certain TV program to another TV program or vice versa, and the like are included.

In addition, the extraction unit 220 according to the present embodiment may extract the distribution destination device 10 having executed processing on a CM program. The extraction unit 220 may extract the distribution destination device 10 having actually played back a CM program set for an extraction condition or the distribution destination device 10 having performed skip processing on a CM program, for example, as a target distribution destination device.

In accordance with the above-described functions that the extraction unit 220 according to the present embodiment has, only target distribution destination devices having actually performed predetermined processing on a distribution program can be extracted on the basis of log information received from many places throughout the country, and it is possible to achieve marketing activities and the like in a wide range at low cost.

### (Identifier Specifying Unit 230)

The identifier specifying unit 230 according to the present embodiment has a function of acquiring an identifier of a guidance target associated with the identifier of a target distribution destination device extracted by the extraction unit 220. As described above, an application, a service, OS, a device, or the like may be included in the guidance target according to the present embodiment. The above-described guidance target is associated with the distribution destination device 10 in advance on the basis of a manipulation made by a user, for example. In accordance with the above-described function that the identifier specifying unit 230 according to the present embodiment has, it is possible to specify an identifier of another modal held by the user of the distribution destination device 10.

In addition, the identifier specifying unit 230 according to the present embodiment is also capable of acquiring the identifier of the guidance target on the basis of the IP address. For example, the identifier specifying unit 230 may acquire the identifier of a guidance target associated with the IP address allocated to a specific area or organization. In accordance with the above-described function that the identifier specifying unit 230 according to the present embodiment has, it is possible to effectively limit guidance targets depending on conditions.

In addition, the identifier specifying unit 230 according to the present embodiment can also acquire the identifier of a guidance target that connects to the same network as a target distribution destination device on the basis of the IP address. On this occasion, the identifier specifying unit 230 may acquire only the identifier of a guidance target that connects to the same home network as the target distribution destination device, for example. In accordance with the above-described function that the identifier specifying unit 230 according to the present embodiment has, in a case where a single distribution destination device 10 is used in common in a home or the like, for example, that is, in a case where a plurality of users exists, and the like, it is possible to estimate a user having actually viewed a distribution program with high accuracy. In a case where a device which may be the guidance target does not connect to the same home network as the target distribution destination device when the distribution program is played back, for example, the identifier specifying unit 230 can determine that it is highly likely that the user of the device stays out and is not viewing the distribution program, and exclude the device from the guidance target. In addition, the identifier specifying unit 230 according to the present embodiment can also acquire the identifier of the guidance target on the basis of proximity sensing through use of a beacon technology such as Bluetooth (registered trademark) or Bluetooth Low Energy (BLE), for example. That is, the identifier specifying unit 230 may acquire only the identifier of a guidance target positioned within predetermined distances from the distribution destination device 10.

### (Guidance Control Unit 240)

The guidance control unit 240 according to the present embodiment has a function of, on the basis of the identifier of the guidance target acquired by the identifier specifying unit 230, causing the guidance target to display guidance information that directs to related content pertaining to a distribution program. In accordance with the above-described function that the guidance control unit 240 according to the present embodiment has, it is possible to guide a user having actually viewed a TV program to the related content, for example, and it is possible to achieve more accurate marketing activities at low cost.

In addition, the guidance control unit 240 according to the present embodiment may further cause a similar target having a tendency similar to that of the guidance target to display the guidance information. Here, the above-described similar target may be a target whose activity tendency on an application or a service is similar to that of the guidance target. An example includes a case where the tendency of TV program information viewed in an application or the tendency of information viewed or followed in a social networking service (SNS) is similar to that of the guidance target, or the like. In accordance with the above-described function that the guidance control unit 240 according to the present embodiment has, even in a case where the user uses a playback device not having the function of transmitting log information, or the like, a viewing activity of the user or the like can be estimated with high accuracy, and it is possible to achieve marketing activities in a wider range.

In addition, in a case where the guidance target according to the present embodiment is an advertisement ID described above, the guidance control unit 240 may cause a list of advertisement IDs acquired by the identifier specifying unit 230 to be transmitted to a DSP server installed by a Demand-Side Platform (DSP) organization or the like. In accordance with the above-described function that the guidance control unit 240 according to the present embodiment has, it is also possible to cause a modal other than the guidance target associated in advance with the distribution destination device 10 to display guidance information, and it is possible to achieve marketing activities in a wider range and the like.

### (Push Notification Unit 250)

The push notification unit 250 according to the present embodiment has a function of making a push notification that prompts for activation of a guidance target. On the basis of a fact that the guidance target has not been activated, for example, the push notification unit 250 can cause the information processing terminal 30 to display a message or the like that prompts for activation of an application, a service, or the like which is a guidance target. In accordance with the above-described function that the push notification unit 250 according to the present embodiment has, even in a case where the guidance target has not been activated, it is possible to increase the possibility that the user checks the guidance information, and it is possible to achieve more efficient marketing activities.

### (Analysis Unit 260)

The analysis unit 260 according to the present embodiment has a function of carrying out various analyses based on log information stored in the storage unit 210 and input information for related content input via the information processing terminal 30. On this occasion, the analysis unit 260 according to the present embodiment can perform an analysis in which the log information and input information are associated on the basis of the identifier of a target distribution destination device and the identifier of a guidance target.

For example, in a case where the related content is a questionnaire, the analysis unit 260 is capable of performing an analysis in which input information for the questionnaire and a viewing log of a user having made input for the questionnaire are associated. In accordance with the above-described function that the analysis unit 260 according to the present embodiment has, actual log information for the distribution program and input information for the related content can be tracked consistently, and it is possible to achieve a more accurate analysis. In addition, the analysis unit 260 may have a function of outputting an analysis result as a report, for example.

### (Communication Unit 270)

The communication unit 270 according to the present embodiment has a function of performing information communication with the distribution destination device 10, the information processing terminal 30, the content server 40, a DSP server (not illustrated), and the like via the network 50. Specifically, the communication unit 270 according to the present embodiment receives log information, an identifier, an IP address, and the like from the distribution destination device 10. In addition, the communication unit 270 transmits control information pertaining to display of guidance information and a push notification to the information processing terminal 30. In addition, the communication unit 270 receives input information for the related content from the content server 40.

The functional configuration example of the information processing device 20 according to the present embodiment has been described above. Note that the above-described configuration described using FIG. 4 is merely an example, and the functional configuration of the information processing device 20 according to the present embodiment is not limited to such an example. For example, the respective functions described above may be achieved by being distributed to a plurality of devices. The functions that the storage unit 210, the extraction unit 220, the identifier specifying unit 230, the guidance control unit 240, the push notification unit 250, and the analysis unit 260 have can also be achieved by separate devices, respectively. In addition, the information processing device 20 according to the present embodiment may further include components other than those described above. The information processing device 20 can further include an input unit that receives an input manipulation, an output unit that outputs various types of information, and the like, for example. The functional configuration of the information processing device 20 according to the present embodiment may be modified flexibly.

### 1.5. Functional Configuration Example of Information Processing Terminal 30

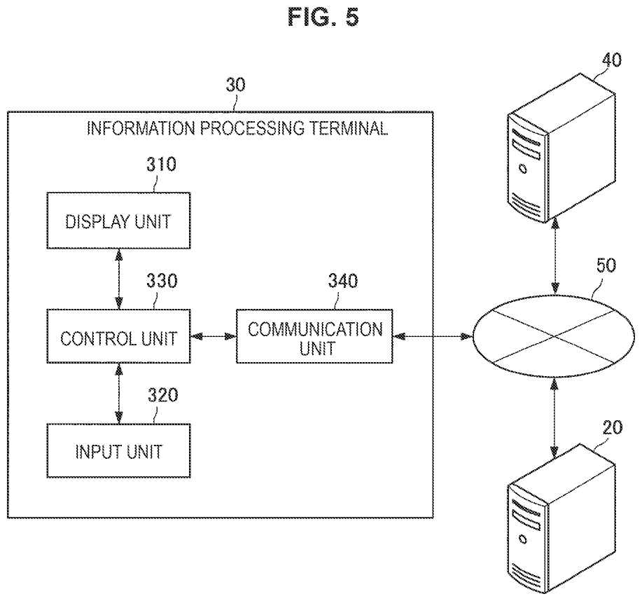

Next, a functional configuration example of the information processing terminal 30 according to the present embodiment will be described. FIG. 5 is an example of a functional block diagram of the information processing terminal 30 according to the present embodiment. Referring to FIG. 5, the information processing terminal 30 according to the present embodiment includes a display unit 310, an input unit 320, a control unit 330, and a communication unit 340.

### (Display Unit 310)

The display unit 310 according to the present embodiment has a function of displaying a user interface of a guidance target and the like. In particular, one of characteristics of the display unit 310 according to the present embodiment is to display guidance information that directs to related content. For this purpose, the display unit 310 according to the present embodiment includes a display device that outputs visual information. Examples of the above-described display device include a cathode ray tube (CRT) display device, a liquid crystal display (LCD) device, and an organic light emitting diode (OLED) device.

### (Input Unit 320)

The input unit 320 according to the present embodiment has a function of detecting an input manipulation made by a user. The input unit 320 according to the present embodiment detects a selective manipulation such as a click on guidance information made by the user, input to related content, and the like, for example. For this purpose, the input unit 320 according to the present embodiment includes an input device such as a keyboard, a mouse, a button, a switch, and a touch panel, for example.

### (Control Unit 330)

The control unit 330 according to the present embodiment has a function of integrally controlling operation of each component included in the information processing terminal 30. The control unit 330 may perform a behavior of a user interface displayed on the display unit 310, processing of input information detected by the input unit 320, and the like, for example. In addition, the control unit 330 according to the present embodiment may cause the display unit 310 to display guidance information and a push notification on the basis of control exerted by the guidance control unit 240, the push notification unit 250, and the like of the information processing device 20.

### (Communication Unit 340)

The communication unit 340 according to the present embodiment has a function of performing information communication with the information processing device 20 and the content server 40 via the network 50. Specifically, the communication unit 340 receives a display of guidance information and control information pertaining to a push notification from the information processing device 20. In addition, the communication unit 340 receives information pertaining to related content from the content server 40 on the basis of an input manipulation made by a user. In addition, the communication unit 340 transmits input information for the related content to the content server 40. Note that contents of an answer to a questionnaire, a history of display or playback of information in the related content, records of accesses to the related content, and the like, for example, may be included in the above-described input information for the related content. In addition, the communication unit 340 transmits the identifier of a guidance target to the content server 40 together with the above-described input information.

The functional configuration example of the information processing terminal 30 according to the present embodiment has been described above. Note that the above-described configuration described using FIG. 5 is merely an example, and the functional configuration of the information processing terminal 30 according to the present embodiment is not limited to such an example. The functional configuration of the information processing terminal 30 according to the present embodiment may be modified flexibly.

### 1.6. Functional Configuration Example of Content Server 40

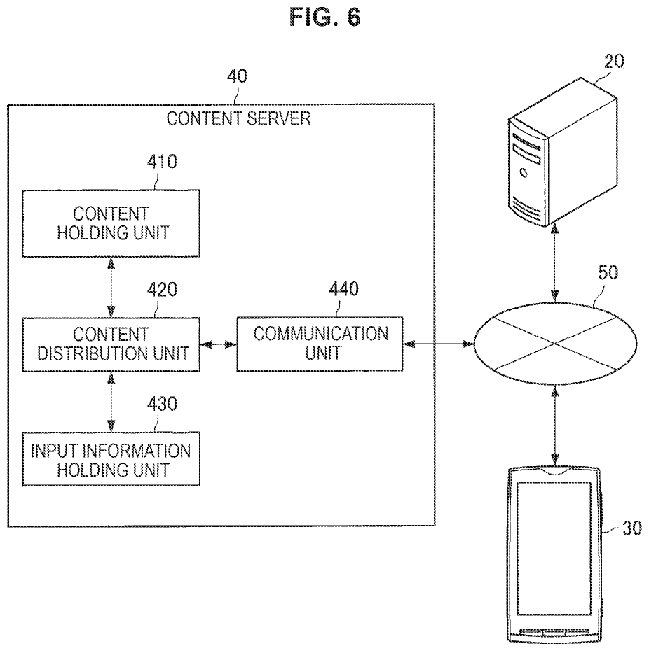

Next, a functional configuration example of the content server 40 according to the present embodiment will be described. FIG. 6 is an example of a functional block diagram of the content server 40 according to the present embodiment. Referring to FIG. 6, the content server 40 according to the present embodiment includes a content holding unit 410, a content distribution unit 420, an input information holding unit 430, and a communication unit 440.

### (Content Holding Unit 410)

The content holding unit 410 according to the present embodiment has a function of holding the contents of related content. The content holding unit 410 may hold text information, image information, or the like pertaining to a questionnaire or an advertisement displayed on the information processing terminal 30, for example. For example, in a case where the distribution program is a TV program, a questionnaire or advertisement content produced by a TV station, a production company, an intermediary, or the like may be registered in advance in the content holding unit 410.

### (Content Distribution Unit 420)

The content distribution unit 420 according to the present embodiment has a function of distributing related content held by the content holding unit 410 on the basis of a request from the information processing terminal 30. For this purpose, the content distribution unit 420 according to the present embodiment may have a function as a web server, for example.

### (Input Information Holding Unit 430)

The input information holding unit 430 according to the present embodiment has a function of holding input information for related content transmitted from the information processing terminal 30. In addition, the identifier of guidance information transmitted together with the above-described input information is stored together in the input information holding unit 430. Note that input information held by the input information holding unit 430 according to the present embodiment may be synchronized with the storage unit 210 of the information processing device 20 regularly or irregularly.

### (Communication Unit 440)

The communication unit 440 according to the present embodiment has a function of performing information communication with the information processing device 20 and the information processing terminal 30 via the network 50. Specifically, the communication unit 440 according to the present embodiment distributes related content to the information processing terminal 30, and receives input information for the related content and the identifier of a guidance target from the information processing terminal 30. In addition, the communication unit 440 transmits input information for the related content held by the input information holding unit 430 to the information processing device 20 regularly or irregularly.

The functional configuration of the content server 40 according to the present embodiment has been described above. Note that the above-described configuration described using FIG. 6 is merely an example, and the functional configuration of the content server 40 according to the present embodiment is not limited to such an example. For example, the content server 40 according to the present embodiment may include a configuration equivalent to that of the analysis unit 260 of the information processing device 20. In this case, the content server 40 can perform various analyses by acquiring log information based on the identifier of a guidance target from the information processing device 20. The functional configuration of the content server 40 according to the present embodiment may be modified flexibly.

### 1.7. Specific Example of Display Control Pertaining to Guidance Information

Next, a specific example of display control pertaining to guidance information in the present embodiment will be described. As described above, on the basis of the identifier of a guidance target, the guidance control unit 240 according to the present embodiment can cause the guidance target to display guidance information that directs to related content pertaining to a distribution program.

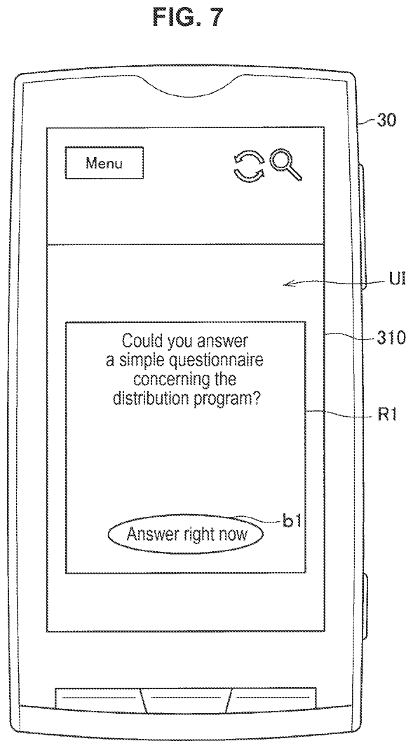

FIG. 7 is a diagram showing an example of guidance information displayed on the display unit 310 of the information processing terminal 30. Note that an example in a case where the guidance target according to the present embodiment is an application associated with the distribution destination device 10 is shown in FIG. 7. The above-described application may be an application having a function of displaying a program table of TV programs and a function as a remote controller, for example.

On this occasion, the display unit 310 according to the present embodiment displays guidance information R1 on a user interface UI of the application under the control exerted by the guidance control unit 240 as shown in FIG. 7. Here, a message for guidance to related content and a link b1 for access to the related content may be included in the guidance information R1 as illustrated.

A user can make access to the related content by clicking the link b1, for example, and answer a questionnaire or the like. In addition, when access to the related content is made from guidance information, the guidance control unit 240 according to the present embodiment may exert control such that the identifier of the guidance target is delivered to the related content. The guidance control unit 240 can control guidance information such that an advertisement ID of the guidance target is transmitted to the content server 40 as a parameter, for example.

Note that an example in a case where a message and the link b1 are displayed as guidance information is shown in FIG. 7, whilst the guidance control unit 240 may automatically create a banner screen in accordance with a viewing scene pertaining to a TV program, or may cause captures of the TV program and the like to be included in the guidance information, for example.

In addition, the guidance control unit 240 may exert control such that guidance information is not displayed on a guidance target having already made access to the related content, or may exert control such as, in a case where access to the related content is not made even if guidance information is displayed a predetermined times or more, not displaying the guidance information from the next time. Furthermore, in a case where it is estimated that the information processing terminal 30 is in a moving state on the basis of information of an acceleration sensor, GPS, and the like included in the information processing terminal 30, for example, the guidance control unit 240 is also capable of exerting control such as not displaying the guidance information.

In addition, the guidance control unit 240 according to the present embodiment is also capable of causing guidance information based on input information for the related content to be displayed. The guidance control unit 240 may cause a guidance target answered that the user is interested in a TV program to display guidance information that announces the next broadcasting schedule and the like, for example.

In addition, the guidance control unit 240 may cause guidance information to be displayed immediately after broadcasting of a TV program is terminated or on a designated day or time zone, or may cause guidance information to be displayed only in a case where the distribution destination device 10 and the guidance target are connected to the same home network. In addition, the guidance control unit 240 can also cause guidance information to be displayed on the basis of a fact that it is sensed by Bluetooth or the like that a guidance target is positioned within predetermined distances from the distribution destination device 10.

As described above, the guidance control unit 240 according to the present embodiment can cause a guidance target to display guidance information that directs to related content on the basis of various conditions. In addition, as described above, the guidance control unit 240 according to the present embodiment may cause a similar target having a tendency similar to that of the guidance target to display guidance information, in addition to the guidance target. In accordance with the above-described functions that the guidance control unit 240 according to the present embodiment has, it is possible to perform wide-range and low-cost marketing activities on the basis of actual log information pertaining to the distribution program, and highly accurate information collection and information transmission can be achieved.

In addition, the information processing device 20 according to the present embodiment has a function of increasing the possibility that the user checks guidance information even in a case where the guidance target has not been activated. Specifically, the push notification unit 250 of the information processing device 20 can make a push notification that prompts for activation of the guidance target on the basis of a fact that the guidance target has not been activated.

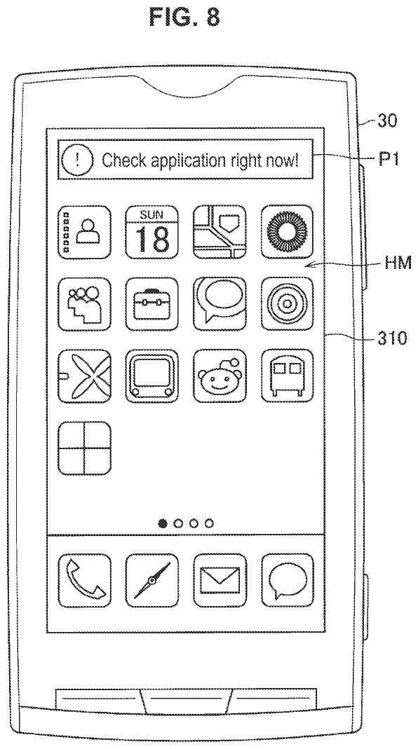

FIG. 8 is a diagram showing an example of a push notification according to the present embodiment. FIG. 8 shows an example of a push notification P1 displayed on a home screen HM of the information processing terminal 30. In this manner, when the push notification unit 250 according to the present embodiment prompts for activation of the guidance target by means of the push notification P1, it is possible to significantly increase the possibility that the user checks the guidance information. The push notification according to the present embodiment is expected to produce particularly high effects in a situation where the time until related content is accessed is important, such as a case where it is desired to have the user make access to the related content immediately after a predetermined scene in a TV program is broadcasted.

Note that the above-described description through use of FIG. 7 and FIG. 8 has been given using a case where the guidance target according to the present embodiment is an application as an example, whilst the guidance target according to the present embodiment is not limited to such an example as described above. The guidance target according to the present embodiment may be various services such as, for example, an SNS and a web page. In this case, the guidance control unit 240 according to the present embodiment can cause guidance information to be displayed on an SNS or a web page. In addition, the guidance control unit 240 according to the present embodiment is also capable of causing a plurality of guidance targets such as an application and an SNS to display guidance information at the same time. Contents of control exerted by the guidance control unit 240 according to the present embodiment may be designed as appropriate in accordance with properties of a distribution program or related content.

### 1.8. Examples of Analyses Performed by Analysis Unit 260

Next, examples of analyses performed by the analysis unit 260 according to the present embodiment will be described. As described above, the analysis unit 260 according to the present embodiment can perform various analyses on the basis of log information stored in the storage unit 210 and input information for related content. On this occasion, the analysis unit 260 according to the present embodiment can achieve an analysis in which log information and input information are associated, on the basis of the identifier of the distribution destination device 10 and the identifier of a guidance target acquired together with input information for related content.

For example, the analysis unit 260 according to the present embodiment may analyze a relationship pertaining to a viewing time of a predetermined TV program and viewing recognition of the TV program. That is, the analysis unit 260 can analyze how long viewing time is required for the tendency recognized that a user has viewed the TV program. On this occasion, for example, the analysis unit 260 can perform the above-described analysis by acquiring a playback time pertaining to a predetermined TV program from log information, and acquiring information about an answer to a questionnaire that “Did you view a program A (the name of a predetermined TV program)?” from input information to related content. In accordance with the analysis, it is possible to obtain a more valuable analysis result in which user's awareness is reflected different from a simple analysis through use of log information.

In addition, for example, the analysis unit 260 may analyze a viewing intention with respect to a predetermined TV program, of a user viewing another program broadcasted in the same time slot as the above-described predetermined TV program. That is, the analysis unit 260 can analyze the degree of user's interest in the predetermined TV program and its reason. On this occasion, for example, the analysis unit 260 can perform the above-described analysis by acquiring the time for which the other TV program has been viewed from log information, and acquiring information about an answer to a questionnaire that “Would you like to view the program A (the name of the predetermined TV program)?” from input information to related content. Here, selective information such as “Strongly agree”, “Agree a little”, “Neither agree nor disagree”, “Disagree a little”, or “Strongly disagree”, its reason, and the like, for example, may be included in the above-described answer information. In accordance with the analysis, it is possible to obtain useful information for future measures for increasing ratings.

In addition, for example, the analysis unit 260 may analyze a reaction and awareness of a user having viewed a predetermined CM program with respect to a promotional product introduced in the CM program. For example, the analysis unit 260 can analyze whether or not a user viewed the CM program has actually purchased the promotional product, or whether or not the willingness to purchase has increased. On this occasion, for example, the analysis unit 260 can perform the above-described analysis by acquiring information about whether or not the predetermined CM program is played back in the distribution destination device 10 from log information, and acquiring information about an answer to a questionnaire that “Did you actually purchase a product B (the name of a promotional product)?” or “Has the willingness to purchase the product B been increased?” from input information for the related content. In accordance with the analysis, it is possible to obtain a highly accurate analysis result in which only an answer from a user having actually viewed the CM program is used. In addition, for example, the analysis unit 260 is also capable of analyzing awareness of a user having viewed an advertisement on a cross-media by considering an advertisement viewing history on a web together, in addition to the above-described answer information.

The analyses performed by the analysis unit 260 according to the present embodiment have been described above using specific examples. Note that the analyses described above are mere examples, and the analyses performed by the analysis unit 260 according to the present embodiment are not limited to such examples. The analysis unit 260 according to the present embodiment is capable of performing various analyses in accordance with a distribution program or the contents of related content.

In addition, in the present embodiment, measures for increasing user's motivation to answer a questionnaire, or the like may be performed by reflecting contents of an answer to the questionnaire in a distribution program, for example. In addition, the information processing device 20 can also increase user's motivation to answer by distributing an incentive such as a coupon that can be used in an EC site or a brick and mortar shop to a user having answered the questionnaire.

Note that, as described above, the analysis function according to the present embodiment may not necessarily be achieved as a function of the information processing device 20. The function corresponding to the analysis unit 260 according to the present embodiment may be achieved as a function of the content server 40, or may be achieved as a function of a device separate from the information processing device 20 or the content server 40.

### 1.9. Flow of Operation of Information Processing Device 20

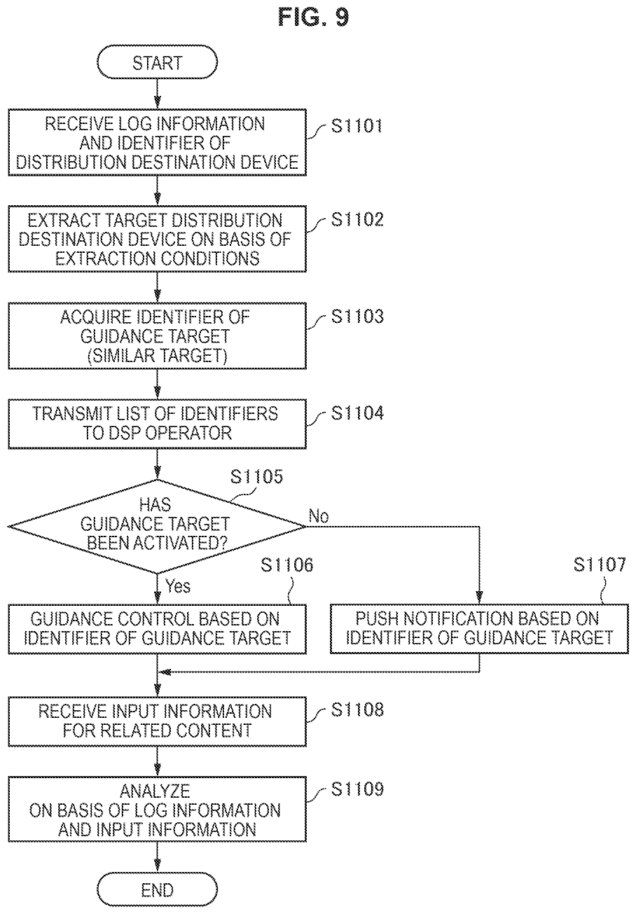

Next, a flow of operation of the information processing device 20 according to the present embodiment will be described in detail. FIG. 9 is a flowchart showing a flow of operation of the information processing device 20 according to the present embodiment.

Referring to FIG. 9, first, the communication unit 270 of the information processing device 20 receives log information and an identifier from the distribution destination device 10 (S1101). In addition, on this occasion, the communication unit 270 may receive the IP address of the distribution destination device 10 together.

Next, the extraction unit 220 according to the present embodiment extracts a target distribution destination device based on extraction conditions (S1102).

Next, the identifier specifying unit 230 according to the present embodiment acquires the identifier of a guidance target corresponding to the identifier of the target distribution destination device extracted in step S1102 (S1103). On this occasion, the identifier specifying unit 230 may acquire the identifier of the guidance target on the basis of the IP address, as described above. In addition, the identifier specifying unit 230 can also acquire the identifier of a similar target together.

Here, in a case where the identifier of the guidance target acquired in step S1103 is an advertisement ID or the like, the guidance control unit 240 according to the present embodiment may cause a list of the above-described advertisement IDs to be transmitted to a DSP server installed by a DSP operator (S1104).

Next, the guidance control unit 240 determines whether or not the guidance target has been activated (S1105).

Here, in a case where the guidance control unit 240 determines that the guidance target has not been activated (S1105: No), the push notification unit 250 according to the present embodiment causes the communication unit 270 to transmit a push notification that prompts for activation of the guidance target on the basis of the identifier of the guidance target acquired in step S1103 (S1107).

On the other hand, in a case where the guidance control unit 240 determines that the guidance target has been activated (S1105: Yes), then, the guidance control unit 240 performs guidance control based on the identifier of the guidance target acquired in step 1103 (S1106). Specifically, the guidance control unit 240 may generate a control signal for causing guidance information to be displayed, and may cause the communication unit 270 to transmit the control signal.

In addition, the communication unit 270 receives input information for related content from the content server 40 regularly or irregularly (S1108).

Next, the analysis unit 260 according to the present embodiment performs various analyses on the basis of the log information received in step 51101 and the input information for the related content received in step S1108 (S1109).

### 2. Hardware Configuration Example

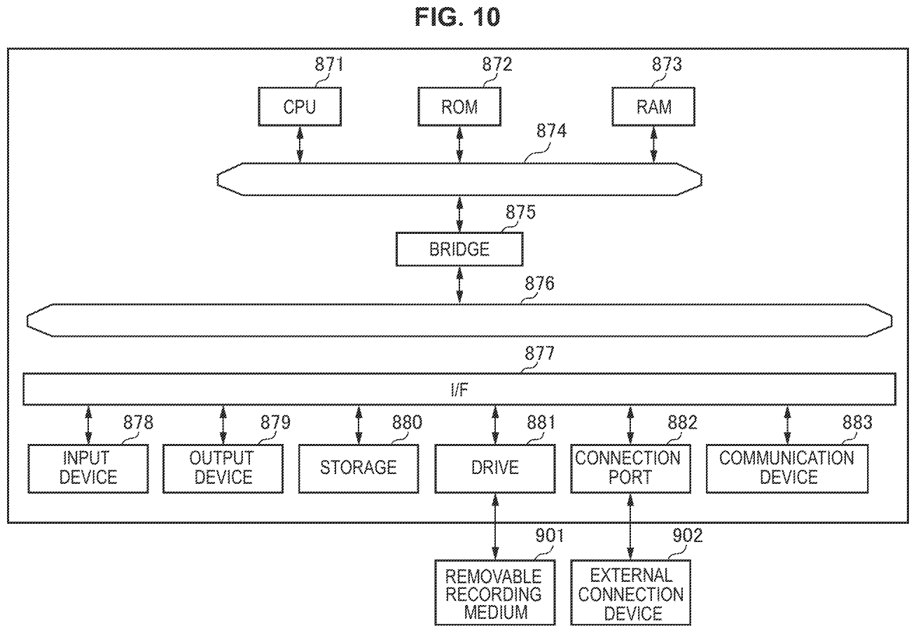

An example of the hardware configuration common to the information processing device 20, the information processing terminal 30, and the content server 40 according to the present disclosure is now described. FIG. 10 is a block diagram illustrating an example of the hardware configuration of the information processing device 20, the information processing terminal 30, and the content server 40 according to the present disclosure. Referring to FIG. 10, the information processing device 20, the information processing terminal 30, and the content server 40 include, in one example, a CPU 871, a ROM 872, a RAM 873, a host bus 874, a bridge 875, an external bus 876, an interface 877, an input device 878, an output device 879, a storage 880, a drive 881, a connection port 882, and a communication device 883. Moreover, the hardware configuration shown here is illustrative, and some of components can be omitted. In addition, a component other than the components shown here can be further included.

### (CPU 871)

The CPU 871 functions as, in one example, an arithmetic processing unit or a control device, and controls some or all of the operations of each component on the basis of various programs recorded in the ROM 872, the RAM 873, the storage 880, or a removable recording medium 901.

### (ROM 872 and RAM 873)

The ROM 872 is a means for storing programs loaded into the CPU 871, data used for operation, or the like. The RAM 873 temporarily or permanently stores, in one example, a program to be loaded into the CPU 871, various parameters appropriately changing in executing the program, or the like.

### (Host Bus 874, Bridge 875, External Bus 876, and Interface 877)

The CPU 871, the ROM 872, and the RAM 873 are mutually connected via, in one example, the host bus 874 capable of high-speed data transmission. On the other hand, the host bus 874 is connected to the external bus 876 having a relatively low data transmission rate, in one example, via the bridge 875. In addition, the external bus 876 is connected to various components via the interface 877.

### (Input Device 878)

Examples of the input device 878 include a mouse, a keyboard, a touch panel, buttons, a switch, a lever, or the like. Furthermore, examples of the input device 878 include a remote controller capable of transmitting a control signal using infrared rays or other radio waves (hereinafter referred to as a remote controller).

### (Output Device 879)

The output device 879 is a device capable of visually or audibly notifying the user of the acquired information, which includes a display device such as a cathode ray tube (CRT), an LCD, or an organic EL, an audio output device such as a loudspeaker or a headphone, a printer, a mobile phone, a facsimile, or the like.

### (Storage 880)

The storage 880 is a device used to store various types of data. Examples of the storage 880 include a magnetic storage device such as hard disk drives (HDDs), a semiconductor storage device, an optical storage device, a magneto-optical storage device, or the like.

### (Drive 881)

The drive 881 is a device that reads information recorded on the removable recording medium 901 such as a magnetic disk, an optical disk, a magneto-optical disk, or semiconductor memory or writes information to the removable recording medium 901.

### (Removable Recording Medium 901)

Examples of the removable recording medium 901 include a DVD medium, a Blu-ray (registered trademark) medium, an HD DVD medium, various kinds of semiconductor storage media, or the like. Of course, the removable recording medium 901 is preferably, in one example, an IC card or an electronic device mounted with a contactless IC chip.

### (Connection Port 882)

The connection port 882 is a port used for connection with an external connection device 902, such as a universal serial bus (USB) port, an IEEE 1394 port, a small computer system interface (SCSI), an RS-232C port, or an optical audio terminal.

### (External Connection Device 902)

Examples of the external connection device 902 include a printer, a portable music player, a digital camera, a digital video camera, an IC recorder, or the like.

### (Communication Device 883)

The communication device 883 is a communication device used for connection with a network, and examples thereof include a communication card for wired or wireless LAN, Bluetooth (registered trademark), or wireless USB (WUSB), a router for optical communication, a router for asymmetric digital subscriber line (ADSL), or a modem for various communications.

### 3.Conclusion

As described above, the information processing device 20 according to the present disclosure can acquire the identifier of a guidance target associated with a target distribution destination device on the basis of log information received from a plurality of distribution destination devices 10 and various extraction conditions. In addition, the information processing device 20 according to the present disclosure can cause the identification target to display guidance information that directs to related content pertaining to a distribution program on the basis of the acquired identifier of the guidance target. With such a configuration, it is possible to effectively guide a user to the related content pertaining to the distribution program.

The preferred embodiment(s) of the present disclosure has/have been described above with reference to the accompanying drawings, whilst the present disclosure is not limited to the above examples. A person skilled in the art can find various alterations and modifications within the scope of the appended claims, and it should be understood that they will naturally come under the technical scope of the present disclosure.

Further, the respective steps in the processing of the information processing device 20 in this specification are not necessarily executed in chronological order in accordance with the order illustrated in the flowcharts. In one example, the respective steps in the processing of the information processing device 20 can be processed in the order different from the order illustrated in the flowcharts, or can also be processed in parallel.

Further, the effects described in this specification are merely illustrative or exemplified effects, and are not limitative. That is, with or in the place of the above effects, the technology according to the present disclosure can achieve other effects that are clear to those skilled in the art from the description of this specification.

Additionally, the present technology may also be configured as below.

(1)

An information processing device including: an extraction unit configured to, on the basis of log information pertaining to a distribution program and acquired from a distribution destination device, extract a target distribution destination device from a plurality of the distribution destination devices; an identifier specifying unit configured to acquire an identifier of a guidance target associated with an identifier of the target distribution destination device; and a guidance control unit configured to cause the guidance target to display guidance information that directs to related content pertaining to the distribution program on the basis of the identifier of the guidance target.

(2)

The information processing device according to (1), in which the identifier specifying unit acquires the identifier of the guidance target specified on the basis of an IP address.

(3)

The information processing device according to (1) or (2), in which the identifier specifying unit acquires the identifier of the guidance target that connects to a same network as the target distribution destination device on the basis of an IP address.

(4)

The information processing device according to any one of (1) to (3), in which the extraction unit extracts a distribution destination device having executed processing on the distribution program as the target distribution destination device on the basis of the log information.

(5)

The information processing device according to (4), in which the processing on the distribution program includes processing pertaining to playback or recording.

(6)

The information processing device according to any one of (1) to (5), in which when access is made from the guidance information that directs to the related content, the guidance control unit exerts control such that the identifier of the guidance target is delivered to the related content.

(7)

The information processing device according to any one of (1) to (6), in which the guidance control unit further causes a similar target having a tendency similar to a tendency of the guidance target to display the guidance information.

(8)

The information processing device according to any one of (1) to (8), further including: a push notification unit configured to perform a push notification that prompts for activation of the guidance target.

(9)

The information processing device according to (8), in which the push notification unit performs the push notification on the basis of a fact that the guidance target has not been activated.

(10)

The information processing device according to any one of (1) to (9), further including: an analysis unit configured to carry out an analysis based on the log information and input information for the related content.

(11)

The information processing device according to (10), in which the analysis unit performs an analysis in which the log information and the input information are associated, on the basis of the identifier of the target distribution destination device and the identifier of the guidance target.

(12)

The information processing device according to any one of (1) to (11), in which the related content includes at least one of a questionnaire or an advertisement.

(13)

The information processing device according to any one of (1) to (12), in which the distribution program includes a video program, and the distribution destination device includes at least one of a playback device or a recording device for the video program.

(14)

The information processing device according to any one of (1) to (13), in which the guidance target includes at least any of an application, a service, or a device associated with the distribution destination device.

(15)

The information processing device according to any one of (1) to (14), in which the identifier of the guidance target includes an advertisement ID, and the guidance control unit causes the advertisement ID to be transmitted to a DSP server.

(16)

An information processing method including: with a processor, on the basis of log information pertaining to a distribution program and acquired from a distribution destination device, extracting a target distribution destination device from a plurality of the distribution destination devices; acquiring an identifier of a guidance target associated with an identifier of the target distribution destination device; and causing the guidance target to display guidance information that directs to related content pertaining to the distribution program on the basis of the identifier of the guidance target.

(17)

A program for causing a computer to function as an information processing device, the information processing device including an extraction unit configured to, on the basis of log information pertaining to a distribution program and acquired from a distribution destination device, extract a target distribution destination device from a plurality of the distribution destination devices, an identifier specifying unit configured to acquire an identifier of a guidance target associated with an identifier of the target distribution destination device, and a guidance control unit configured to cause the guidance target to display guidance information that directs to related content pertaining to the distribution program on the basis of the identifier of the guidance target.

(18)

An information processing system including: an extraction unit configured to, on the basis of log information pertaining to a distribution program and acquired from a distribution destination device, extract a target distribution destination device from a plurality of the distribution destination devices; an identifier specifying unit configured to acquire an identifier of a guidance target associated with an identifier of the target distribution destination device; and a guidance control unit configured to cause the guidance target to display guidance information that directs to related content pertaining to the distribution program on the basis of the identifier of the guidance target; and a display unit configured to display the guidance information on the basis of control exerted by the guidance control unit.

### REFERENCE SIGNS LIST

10 distribution destination device
110 distribution program processing unit
120 control unit
130 log holding unit
140 communication unit
20 information processing device
210 storage unit
220 extraction unit
230 identifier specifying unit
240 guidance control unit
250 push notification unit
260 analysis unit
270 communication unit
30 information processing terminal
310 display unit
320 input unit
330 control unit
340 communication unit
40 content server
410 content holding unit
420 content distribution unit
430 input information holding unit
440 communication unit

1. An information processing device comprising:
an extraction unit configured to, on a basis of log information pertaining to a distribution program and acquired from a distribution destination device, extract a target distribution destination device from a plurality of the distribution destination devices;
an identifier specifying unit configured to acquire an identifier of a guidance target associated with an identifier of the target distribution destination device; and
a guidance control unit configured to cause the guidance target to display guidance information that directs to related content pertaining to the distribution program on a basis of the identifier of the guidance target.

2. The information processing device according to claim 1, wherein
the identifier specifying unit acquires the identifier of the guidance target specified on a basis of an IP address.

3. The information processing device according to claim 1, wherein
the identifier specifying unit acquires the identifier of the guidance target that connects to a same network as the target distribution destination device on a basis of an IP address.

4. The information processing device according to claim 1, wherein
the extraction unit extracts a distribution destination device having executed processing on the distribution program as the target distribution destination device on a basis of the log information.

5. The information processing device according to claim 4, wherein
the processing on the distribution program includes processing pertaining to playback or recording.

6. The information processing device according to claim 1, wherein
when access is made from the guidance information that directs to the related content, the guidance control unit exerts control such that the identifier of the guidance target is delivered to the related content.

7. The information processing device according to claim 1, wherein
the guidance control unit further causes a similar target having a tendency similar to a tendency of the guidance target to display the guidance information.

8. The information processing device according to claim 1, further comprising:
a push notification unit configured to perform a push notification that prompts for activation of the guidance target.

9. The information processing device according to claim 8, wherein
the push notification unit performs the push notification on a basis of a fact that the guidance target has not been activated.

10. The information processing device according to claim 1, further comprising:
an analysis unit configured to carry out an analysis based on the log information and input information for the related content.

11. The information processing device according to claim 10, wherein
the analysis unit performs an analysis in which the log information and the input information are associated, on a basis of the identifier of the target distribution destination device and the identifier of the guidance target.

12. The information processing device according to claim 1, wherein
the related content includes at least one of a questionnaire or an advertisement.

13. The information processing device according to claim 1, wherein
the distribution program includes a video program, and
the distribution destination device includes at least one of a playback device or a recording device for the video program.

14. The information processing device according to claim 1, wherein
the guidance target includes at least any of an application, a service, or a device associated with the distribution destination device.

15. The information processing device according to claim 1, wherein
the identifier of the guidance target includes an advertisement ID, and
the guidance control unit causes the advertisement ID to be transmitted to a DSP server.

16. An information processing method comprising:
with a processor, on a basis of log information pertaining to a distribution program and acquired from a distribution destination device, extracting a target distribution destination device from a plurality of the distribution destination devices;
acquiring an identifier of a guidance target associated with an identifier of the target distribution destination device; and
causing the guidance target to display guidance information that directs to related content pertaining to the distribution program on a basis of the identifier of the guidance target.

17. A program for causing a computer to function as an information processing device, the information processing device including
an extraction unit configured to, on a basis of log information pertaining to a distribution program and acquired from a distribution destination device, extract a target distribution destination device from a plurality of the distribution destination devices,
an identifier specifying unit configured to acquire an identifier of a guidance target associated with an identifier of the target distribution destination device, and
a guidance control unit configured to cause the guidance target to display guidance information that directs to related content pertaining to the distribution program on a basis of the identifier of the guidance target.

18. An information processing system comprising:
an extraction unit configured to, on a basis of log information pertaining to a distribution program and acquired from a distribution destination device, extract a target distribution destination device from a plurality of the distribution destination devices;
an identifier specifying unit configured to acquire an identifier of a guidance target associated with an identifier of the target distribution destination device; and
a guidance control unit configured to cause the guidance target to display guidance information that directs to related content pertaining to the distribution program on a basis of the identifier of the guidance target; and
a display unit configured to display the guidance information on a basis of control exerted by the guidance control unit.
